(19) United States
(12) Patent Application Publication
(10) Pub. No.: US 2017/0321029 A1
(43) Pub. Date: Nov. 9, 2017

(54) THERMOPLASTIC POLYESTER RESIN COMPOSITION AND MOLDED ARTICLE

(71) Applicant: Toray Industries, Inc., Tokyo (JP)

(72) Inventors: Ken Sudo, Nagoya-shi (JP); Yusuke Tojo, Nagoya-shi (JP); Kenichi Utazaki, Nagoya-shi (JP)

(21) Appl. No.: 15/526,840

(22) PCT Filed: Jul. 22, 2015
(86) PCT No.: PCT/JP2015/070882

§ 371 Date: May 15, 2017

(30) Foreign Application Priority Data
Nov. 19, 2014 (JP) 2014-234072

(51) Int. Cl. C08K 3/16; C08J 3/20; C08K 5/372

(52) U.S. Cl. CPC C08K 3/16; C08K 5/372; C08J 3/20; C08J 2367/02

(57) ABSTRACT

A thermoplastic polyester resin composition includes 100 parts by weight of a thermoplastic polyester resin (A) having a melting point of 180 to 250° C. and 0.01 to 1 part by weight of a metal halide (B), wherein an area average particle size of the metal halide (B) in the thermoplastic polyester resin composition is 0.1 to 500 nm. The thermoplastic polyester resin composition has an excellent melt retention stability and is capable of producing a molded article excellent in mechanical properties and long-term resistance to oxidative degradation.

### TECHNICAL FIELD

This disclosure relates to a thermoplastic polyester resin composition and a molded article obtainable by molding the same.

### BACKGROUND

Thermoplastic polyester resins have been used in a wide range of fields, for example, in mechanical machine parts, electric/electronic components and automotive parts, utilizing their excellent injection moldability, mechanical properties and other features. However, the thermoplastic polyester resins are susceptible to decreasing mechanical strength by oxidative degradation at raised temperature. Therefore, to use the thermoplastic polyester resins as industrial materials such as materials for mechanical machine parts, electric and electronic components and automotive parts, the resins are required to have a long-term resistance to oxidative degradation at raised temperature, in addition to having balanced chemical and physical properties in general. There is recently growing demand for thinning and weight-reducing as well as downsizing of molded articles. Especially for use as a thin-walled molded article such as a connector, thermal degradation during melt-retention causes generation of gas bubbles in the molded article, occurrences of molding failure including decreasing mechanical strength, poor appearance or the like, and reducing hydrolysis resistance due to increasing the amount of carboxyl end groups by thermal degradation. Therefore, a thermally stable material during melt retention having less heat degradation during melt retention is required.

As methods of improving heat stability of thermoplastic resins, there have been proposed so far, for example, a thermoplastic resin composition, including copper iodide and potassium iodide as a copper stabilizer, a polyhydric alcohol, and polymer reinforcement in a thermoplastic resin selected from the group consisting of a polyamide, a polyester, and a mixture thereof, (e.g., JP 2011-529991 T) and a non-fiber-reinforced thermoplastic molding composition, including a polymer composition including at least one kind of thermoplastic polyamide resin, heat stabilizer such as a copper halide/alkali halide, optionally a non-fibrous inorganic filler, and/or another auxiliary additive excepting fibrous reinforcement (e.g., JP 2008-527127 T). However, they are mainly inventions to improve the resistance to oxidative degradation of thermoplastic polyamide resins, and there still remains drawbacks of insufficient resistance to oxidative degradation and mechanical properties.

On the other hand, as a technique of including a metal halide in a thermoplastic polyester resin, there has been proposed a polyester film, including cuprous iodide having an average particle size of from 10 to 800 nm in a polyester (e.g., JP 62-177057 A).

However, JP '057 is directed to a polyethylene terephthalate resin, and there remains a drawback of insufficient resistance to oxidative degradation because an aggregation among cuprous iodide particles by adding them into a polyethylene terephthalate resin, though the average particle size of the cuprous iodide before the addition is small enough, results in a coarse dispersion. Further, there remains a drawback of reduced resistance to oxidative degradation because cuprous iodide is susceptible to heat deterioration during blending since a raised temperature is required to blend cuprous iodide in polyethylene terephthalate having a melting point of higher than 250° C.

It could therefore be helpful to provide a thermoplastic polyester resin composition having an excellent melt retention stability and capable of producing a molded article excellent in mechanical properties and long-term resistance to oxidative degradation; and the molded article.

We found that it is advantageous to add a specific amount of a metal halide (B) to a thermoplastic polyester resin (A) having a specific range of melting point and also by bringing the metal halide (B) to a specific dispersion state. We thus provide:
A thermoplastic polyester resin composition, comprising 100 parts by weight of a thermoplastic polyester resin (A) having a melting point of 180 to 250° C. and from 0.01 to 0.6 parts by weight of a metal halide (B), wherein an area average particle size of the metal halide (B) in the thermoplastic polyester resin composition is from 0.1 to 500 nm.
A molded article comprising the above mentioned thermoplastic polyester resin composition.
A method of producing the thermoplastic polyester resin composition comprising melt-blending the thermoplastic polyester resin (A) having a melting point of from 180 to 250° C. and the metal halide (B) using a twin-screw extruder, wherein the ratio of the total length of a kneading disc to a full length of a screw of the twin-screw extruder is from 5 to 50%.

The thermoplastic polyester resin composition has an excellent melt retention stability. Therefore, the thermoplastic polyester resin composition is capable of producing a molded article which is excellent in mechanical properties and long-term resistance to oxidative degradation.

### DETAILED DESCRIPTION

The thermoplastic polyester resin composition will be described in detail.

The thermoplastic polyester resin composition (hereinafter referred to as “the resin composition”) comprises a thermoplastic polyester resin (A) having a melting point of from 180 to 250° C. (hereinafter referred to as “the thermoplastic polyester resin (A)”) and metal halide (B).

The melting point of the thermoplastic polyester resin (A) is 180 to 250° C. When the melting point is 180° C. or less, the heat resistance of the molded article is reduced. The melting point is preferably 190° C. or more, and more preferably, 200° C. or more. On the other hand, when the melting point is more than 250° C., since the temperature of a melt process has to be set high and therefore melt retention stability is not enough, heat degradation occurs during the melt process, which results in reduced resistance to oxidative degradation. The melting point is preferably 245° C. or less, and more preferably, 240° C. or less. The melting point is referred to a peak top temperature of homo crystal melting peak of thermoplastic polyester resin (A) measured by differential scanning calorimeter (DSC).

The thermoplastic polyester resin (A) is a polymer comprising, as major structural units, at least one type of residue selected from the group consisting of (1) a dicarboxylic acid or an ester-forming derivative thereof and a diol or an ester-forming derivative thereof, (2) a hydroxycarboxylic acid or an ester-forming derivative thereof, and (3) a lactone. The expression “comprising as major structural units” means that the resin contains at least one type of residue selected from the group consisting of the above mentioned (1) to (3) in an amount of 50% by mole or more. It is preferred that 80% by mole or more of their residues be included. Among these, a polymer which has residues of (1) a dicarboxylic acid or an ester-forming derivative thereof and a diol or an ester-forming derivative thereof as major structural units is preferred in terms of improving mechanical properties and heat resistance.

Examples of the dicarboxylic acid or ester-forming derivative thereof include: aromatic dicarboxylic acids such as terephthalic acid, isophthalic acid, phthalic acid, 2,6-naphthalene dicarboxylic acid, 1,5-naphthalene dicarboxylic acid, bis(p-carboxyphenyl)methane, anthracene dicarboxylic acid, 4,4′-diphenyl ether dicarboxylic acid, 5-tetrabutylphosphonium isophthalic acid, and 5-sodium sulfoisophthalic acid; aliphatic dicarboxylic acids such as oxalic acid, succinic acid, adipic acid, sebacic acid, azelaic acid, dodecanedioic acid, malonic acid, glutaric acid, and dimer acid, alicyclic dicarboxylic acids such as 1,3-cyclohexanedicarboxylic acid, and 1,4-cyclohexanedicarboxylic acid; and ester-forming derivatives thereof; and the like. Two or more of these may be used.

Examples of the diol or ester-forming derivative thereof include: aliphatic and alicyclic glycols having 2 to 20 carbon atoms such as ethylene glycol, propylene glycol, 1,4-butanediol, neopentyl glycol, 1,5-pentanediol, 1,6-hexanediol, decamethylene glycol, cyclohexanedimethanol, cyclohexanediol, and dimer diols; long chain glycols with a molecular weight of from 200 to 100,000 such as polyethylene glycol, poly-1,3-propylene glycol, and polytetramethylene glycol; aromatic dioxy compounds such as 4,4′-dihydroxybiphenyl, hydroquinone, t-butylhydroquinone, bisphenol A, bisphenol S, and bisphenol F; ester-forming derivatives thereof; and the like. Two or more of these may be used.

Examples of the polymer comprising as structural units a dicarboxylic acid or an ester-forming derivative thereof and a diol or an ester-forming derivative thereof include aromatic polyester resins such as polypropylene terephthalate, polybutylene terephthalate, polypropylene isophthalate, polybutylene isophthalate, polybutylene naphthalate, polypropylene isophthalate/terephthalate, polybutylene isophthalate/terephthalate, polypropylene terephthalate/naphthalate, polybutylene terephthalate/naphthalate, polybutylene terephthalate/decane-dicarboxylate, polypropylene terephthalate/5-sodium sulfoisophthalate, polybutylene terephthalate/5 -sodium sulfoisophthalate, polypropylene terephthalate/polyethyl ene glycol, polybutylene terephthalate/polyethylene glycol, polypropylene terephthalate/polytetramethylene glycol, polybutylene terephthalate/polytetramethylene glycol, polypropylene terephthalate/isophthalate/polytetramethylene glycol, polybutylene terephthalate/isophthalate/polytetramethylene glycol, polybutylene terephthalate/succinate, polypropylene terephthalate/adipate, polybutylene terephthalate/adipate, polypropylene terephthalate/sebacate, polybutyl ene terephthalate/sebacate, polypropylene terephthalate/isophthalate/adipate, polybutylene terephthalate/isophthalate/succinate, polybutyl ene terephthalate/isophthalate/adipate, polybutylene terephthalate/isophthalate/sebacate, and the like. As used herein, “/” represents a copolymer.

Among these, a polymer which has residues of an aromatic dicarboxylic acid or an ester-forming derivative thereof and an aliphatic diol or an ester-forming derivative thereof as major structural units is preferred in terms of improving mechanical properties and heat resistance. A polymer which has residues of terephthalic acid, naphthalenedicarboxylic acid or an ester-forming derivative thereof and an aliphatic diol selected from propylene glycol and butanediol or an ester-forming derivative thereof as major structural units is more preferred.

Among these, particularly preferred are aromatic polyester resins such as polypropylene terephthalate, polybutylene terephthalate, polypropylene naphthalate, polybutylene naphthalate, polypropylene isophthalate/terephthalate, polybutylene isophthalate/terephthalate, polypropylene terephthalate/naphthalate and polybutylene terephthalate/naphthalate. More preferred are polybutylene terephthalate, polypropylene terephthalate, and polybutylene naphthalate. Still more preferred is polybutylene terephthalate in terms of improving moldability and crystallinity. Two or more of these compounds may be used at an arbitrary content.

The ratio of the amount of terephthalic acid or ester-forming derivative thereof with respect to the total amount of the dicarboxylic acid in the thermoplastic polyester resin (A) is preferably 30% by mole or more, and more preferably, 40% by mole or more.

As the thermoplastic polyester resin (A), a liquid crystal polyester resin capable of developing anisotropy during melting can also be used. Examples of the structural unit of the liquid crystal polyester resin include: aromatic oxycarbonyl units, aromatic dioxy units, aromatic and/or aliphatic dicarbonyl units, alkylenedioxy units, aromatic iminooxy units and the like.

The thermoplastic polyester resin (A) preferably has a weight average molecular weight (Mw) of greater than 8,000 and not more than 500,000, more preferably, greater than 8,000 and not more than 300,000, and still more preferably, greater than 8,000 and not more than 250,000, in terms of further improving the mechanical properties. The weight average molecular weight (Mw) is most preferably greater than 8,000 and not more than 35,000 in terms of preventing oxidative degradation by shear heating during a melt process. The Mw of the thermoplastic polyester resin (A) is a value in terms of polymethyl methacrylate (PMMA), determined by gel permeation chromatography (GPC) using hexafluoroisopropanol as a solvent.

The thermoplastic polyester resin (A) can be produced by a known method such as polycondensation or ring-opening polymerization. The polymerization method may be either batch polymerization or continuous polymerization, and the reaction may be carried out through transesterification or direct polymerization. In terms of productivity, continuous polymerization is preferred, and direct polymerization is more preferred.

When the thermoplastic polyester resin (A) is a polymer comprising as main components a dicarboxylic acid or an ester-forming derivative thereof and a diol or an ester-forming derivative thereof, the polyester resin can be produced by subjecting the dicarboxylic acid or ester forming derivative thereof and the diol or ester-forming derivative thereof to an esterification reaction or transesterification reaction, followed by a polycondensation reaction.

To efficiently promote an esterification reaction or transesterification reaction and a polycondensation reaction, it is preferred that a polymerization catalyst be added during the reactions. Specific examples of the polymerization catalyst include: organic titanium compounds such as methyl ester, tetra-n-propyl ester, tetra-n-butyl ester, tetraisopropyl ester, tetraisobutyl ester, tetra-tert-butyl ester, cyclohexyl ester, phenyl ester, benzyl ester, and tolyl ester of titanic acid, and mixed esters thereof; tin compounds such as dibutyltin oxide, methylphenyltin oxide, tetraethyltin, hexaethylditin oxide, cyclohexahexylditin oxide, didodecyltin oxide, triethyltin hydroxide, triphenyltin hydroxide, triisobutyltin acetate, dibutyltin diacetate, diphenyltin dilaurate, monobutyltin trichloride, dibutyltin dichloride, tributyltin chloride, dibutyltin sulfide, butylhydroxytin oxide, and alkylstannonic acids such as methylstannonic acid, ethylstannonic acid, and butylstannonic acid; zirconia compounds such as zirconium tetra-n-butoxide; and antimony compounds such as antimony trioxide and antimony acetate and the like. Two or more of these may be used.

Among the above mentioned polymerization reaction catalysts, organic titanium compounds and tin compounds are preferred, and tetra-n-butyl ester of titanic acid is more preferred. The adding amount of the polymerization reaction catalyst is preferably 0.01 to 0.2 parts by weight with respect to 100 parts by weight of the thermoplastic polyester resin.

The thermoplastic polyester resin composition comprises 100 parts by weight of the thermoplastic polyester resin (A) which has a melting point of 180 to 250° C. and 0.01 to 0.6 parts by weight of a metal halide (B), wherein the area average particle size of the metal halide (B) in the resin composition is 0.1 to 500 nm. A thermoplastic polyester resin (A) has excellent injection moldability and mechanical properties, but it tends to generate a radical by withdrawing a hydrogen from the main chain due to oxidative degradation at raised temperature and, therefore, main chain degradation initiated by this radical leads easily to decreased molecular weight. The melt retention stability of the resin composition and the mechanical properties of the molded article are reduced with decreasing molecular weight due to oxidative degradation. Melt retention stability is referred to stability of the resin composition at a temperature of the melting point or more of the thermoplastic polyester resin (A), and a change of carboxyl end groups resulted by main chain degradation of the thermoplastic polyester resin (A) can be used as its indicator. Decreasing the molecular weight due to main chain degradation and increasing carboxyl end groups can be suppressed by effectively capturing radicals due to oxidative degradation the melt retention stability can be improved maintaining high mechanical properties which the thermoplastic polyester resin (A) has, by blending the thermoplastic polyester resin (A) with the metal halide (B) and adjusting so that the area average particle size of the metal halide (B) is 0.1 to 500 nm.

Examples of metal halides (B) include, but are not limited to, alkali metal halides such as lithium iodide, sodium iodide, potassium iodide, lithium bromide, sodium bromide, potassium bromide, lithium chloride, sodium chloride and potassium chloride, alkali earth metal halides such as magnesium iodide, calcium iodide, magnesium bromide, calcium bromide, magnesium chloride and calcium chloride; group 7 metal halides such as manganese(II) iodide, manganese(II) bromide and manganese(II) chloride; group 8 metal halides such as iron(II) iodide, iron(II) bromide and iron(II) chloride; group 9 metal halides such as cobalt(II) iodide, cobalt(II) bromide and cobalt(II) chloride; group 10 metal halides such as nickel(II) iodide, nickel(II) bromide and nickel(II) chloride; group 11 metal halides such as copper(I) iodide, copper(I) bromide and copper(I) chloride; group 12 metal halides such as zinc iodide, zinc bromide and zinc chloride; group 13 metal halides such as aluminum(III) iodide, aluminum(III) bromide and aluminum(III) chloride; group 14 metal halides such as tin(II) iodide, tin(II) bromide and tin(II) chloride; group 15 metal halides such as antimony triiodide, antimony tribromide, antimony trichloride, bismuth(III) iodide, bismuth(III) bromide, bismuth(III) chloride, and the like. Two or more of these may be used in combination. Among these, alkali metal halides are preferred and, among the halides, an alkali metal iodide is more preferred in terms of availability, excellent dispersibility to thermoplastic polyester resin (A), higher reactivity with radicals and improving more resistance to oxidative degradation.

The blending amount of the metal halide (B) is preferably 0.01 to 0.6 parts by weight with respect to 100 parts by weight of the thermoplastic polyester resin (A). Long-term resistance to oxidative degradation and melt retention stability are reduced when the blending amount of the component (B) is less than 0.01 parts by weight. The blending amount is preferably 0.02 parts by weight or more, and more preferably, 0.04 parts by weight or more in terms of improving the resistance to oxidative degradation. On the other hand, when the blending amount of component (B) is more than 0.6 parts by weight, self-aggregation of the metal halide (B) occurs and thereby the dispersion diameter becomes coarse, which tends to lower mechanical properties. Further, the coarse dispersion cause a lowering in the surface area and in the reaction between metal halide (B) and radicals, and thereby the melt retention stability and resistance to oxidative degradation tend to be lowered. The blending amount is preferably 0.5 parts by weight or less, and more preferably, 0.3 parts by weight or less.

The area average particle size of the metal halide (B) in the resin composition is 0.1 to 500 nm. When the area average particle size of the metal halide (B) is more than 500 nm, the resistance to oxidative degradation, melt retention stability and mechanical properties are reduced. The area average particle size is preferably 300 nm or less, and more preferably, 100 nm or less, and still more preferably, 60 nm or less in terms of improving reactivity between the metal halide (B) and radicals.

The area average particle size of the metal halide (B) in the resin composition can be measured by the following method. The area average particle size of the component (B) is measured using ASTM No. 4 dumbbell-shaped test specimens having a thickness of 1/25 inch (about 1.0 mm) or ASTM No. 1 dumbbell-shaped test specimens having a thickness of ⅛ inch (about 3.2 mm) on the basis that the particle size of the component (B) in the molded article is substantially the same as that in the resin composition as long as the molded article is produced in a general molding condition. First, the above-mentioned specimens are prepared by injection-molding with the resin composition in a molding cycle condition in which a molding temperature is a melting point of the component (A) plus about 30° C., and a mold temperature is 80° C. with 10 seconds of the total of injection and retention times and 10 seconds of cooling time. Subsequently, a section having a thickness of 100 μm was cut out of the resulting specimen and the component (A) in the section was stained by iodine staining, and then the ultra-thin section was cut out and observed for a dispersion state of the component (B) at the magnification of 100,000 times with the transmission electron microscope (TEM). At least 100 particles made of metal halide (B) randomly selected were measured for the particle size to calculate the area average particle size according to Equation (1). When a particle is not circular, a longer size is regarded as a particle size.

Area average particle size=Σ(di³×ni)/Σ(di^{e}×ni) (1)

wherein di represents a particle size of the component (B), and ni represents a number of the component (B) having a particle size of di.

It is important that the dispersion state is allowed to be a state in which the area average particle size of the metal halide (B) in the resin composition is 0.1 to 500 nm. Even though the average particle size of the metal halide (B) before adding has been sufficiently small, when the dispersion diameter exceeds the above-mentioned range by aggregation during blending, melt retention stability and resistance to oxidative degradation tend to be reduced. A kind and a blending amount of the metal halide (B) are preferably within the above-mentioned preferred range so that the area average particle size of the metal halide (B) in the resin composition is 0.1 to 500 nm. A preferred producing method will be described later such that the area average particle size of the metal halide (B) in the resin composition is 0.1 to 500 nm.

The resin composition of which a weight average molecular weight retention of the thermoplastic polyester resin (A) after being heat-treated at 180° C. for 250 hours under an atmospheric pressure is 80% or more, is preferred. When the weight average molecular weight retention is 80% or more, the high mechanical properties can be retained more even when the resin composition was exposed under a condition of long-termed raised temperature. The weight average molecular weight retention is preferably 85% or more, and more preferably, 90% or more. The weight average molecular weight retention can be determined by the following method. First, 2.5 mg of the resin composition is dissolved into 3 ml of hexafluoroisopropanol and then the mixture is filtered through a Chromatodisc having a pore size of 0.45 μm to obtain a solution of the thermoplastic polyester resin (A). The weight average molecular weight in terms of PMMA of the resulting solution of the thermoplastic polyester resin (A) is calculated using GPC. This is defined as the weight average molecular weight before heat-treating. Next, the resin composition is heat-treated at a press temperature of 250° C. for 5 minutes using a hot press and crystallized at 110° C. for 5 minutes to obtain a test pressed sheet having a thickness of 600 μm. Subsequently, the resulting test pressed sheet is heat-treated at 180° C. for 250 hours in a Geer oven under an atmospheric pressure. After heat-treating, 2.5 mg of a piece cut out of the test pressed sheet is dissolved in 3 ml of hexafluoroisopropanol and filtered through a Chromatodisc having a pore size of 0.45 μm to obtain a solution of the thermoplastic polyester resin (A) after heating. The weight average molecular weight of the thermoplastic polyester resin (A) after heat-treating is then measured by the same way as mentioned above. The weight average molecular weight retention (%) is calculated with the weight average molecular weight after heat-treating being divided by the weight average molecular weight before heat-treating and being multiplied with 100.

Examples of methods of allowing a weight average molecular weight retention of the thermoplastic polyester resin (A) to be in the above-mentioned preferred range includes, for example, a method of allowing a blending amount of the metal halide (B) in the above-mentioned preferred range, a method of adding an alkali metal halide, especially an alkali metal iodide, which has high radical capture capability as the metal halide (B), and allowing an area average particle size of the metal halide (B) in the resin composition in the above-mentioned preferred range.

When a ¹H-NMR spectrum of the resin composition is measured after heat-treatment at 180° C. for 250 hours under atmospheric pressure, it is preferred that a peak integral of 5.2 to 6.0 ppm in the ¹H-NMR is 0 to 2 if a peak integral at a chemical shift of 3.6 to 4.0 ppm is defined as 100. A peak of 5.2 to 6.0 ppm indicates an unsaturated double bond generated by oxidative degradation of the thermoplastic polyester resin (A) and a peak of 3.6 to 4.0 ppm indicates a methylene group of the thermoplastic polyester resin (A). In the other words, the ratio of the peak integral of 5.2 to 6.0 ppm to the peak integral of 3.6 to 4.0 ppm represents the extent of oxidative degradation of the thermoplastic polyester resin (A) due to heat-treating. When the integral 5.2 to 6.0 ppm is as low as 0 to 2, the high mechanical properties can be retained more even when the resin composition was exposed under a condition of long-termed raised temperature. The peak integral is preferably from 0 to 1, and more preferably, from 0 to 0.5. Each peak integral can be determined by the following method. First, the resin composition is heat-treated at a press temperature of 250° C. for 5 minutes using a hot press and crystallized at 110° C. for 5 minutes to obtain a test pressed sheet having a thickness of 600 μm. Subsequently, the resulting test pressed sheet is heat-treated at 180° C. for 250 hours in a Geer oven under an atmospheric pressure. After heat-treating, 10 mg of a piece cut out of the test pressed sheet is dissolved in 1 ml of deuterated hexafluoroisopropanol, measured for ¹H-NMR spectrum, and calculated to obtain the integrals of 3.6 to 4.0 ppm and 5.2 to 6.0 ppm.

Examples of methods of allowing a peak integral of 5.2 to 6.0 ppm obtained by ¹H-NMR of the resin composition to be in the above-mentioned preferred range includes, for example, a method of allowing a blending amount of the metal halide (B) in the above-mentioned preferred range, a method of adding an alkali metal halide, especially an alkali metal iodide, which has high radical capture capability as the metal halide (B), and allowing an area average particle size of the metal halide (B) in the resin composition in the above-mentioned preferred range.

The molded article, including the resin composition, of which molded article a tensile strength retention after being heat-treated at 180° C. at 250° C. under an atmospheric pressure is 80% or more, is preferred. When the tensile strength retention is 80% or more, the high properties as a molded article can be retained more even when the resin composition was exposed under a condition of long-termed raised temperature. The tensile strength retention is preferably 85% or more, and more preferably, 90% or more. The tensile strength retention of the molded article can be determined by the following method. First, a dumbbell-shaped test specimen is prepared using injection molding machine, and measured for a tensile strength. Subsequently, the test specimen is heat-treated at 180° C. for 250 hours in a Geer oven under an atmospheric pressure and measured for a tensile strength. The tensile strength retention (%) is calculated with the tensile strength after heat-treating being divided by the tensile strength before heat-treating and being multiplied with 100.

Examples of methods of allowing a tensile strength retention of the molded article including the resin composition to be in the above-mentioned preferred range includes, for example, a method of allowing a blending amount of the metal halide (B) in the above-mentioned preferred range, a method of adding an alkali metal halide, especially an alkali metal iodide, which has high radical capture capability as the metal halide (B), and allowing an area average particle size of the metal halide (B) in the resin composition in the above-mentioned preferred range.

It is preferred that the resin composition further include an antioxidant (C). Including an antioxidant (C) can promote to inactivate peroxide radicals generated in the presence of oxygen at raised temperature, and improve the resistance to oxidative degradation and melt retention stability. Examples of the antioxidant (C) include hindered phenol compounds, thioether compounds and the like. Two or more of these may be included.

Examples of hindered phenol compounds include n-octadecyl 3-(3′,5′-di-t-butyl-4′-hydroxyphenyl)propionate, n-octadecyl 3-(3′-methyl-5′-t-butyl-4′-hydroxyphenyl)propionate, n-tetradecyl 3-(3′,5′-di-t-butyl-4′-hydroxyphenyl)propionate, 1,6-hexanediol bis [3-(3,5-di-t-butyl-4-hydroxyphenyl)propionate], 1,4-butanediol bis [3-(3,5-di-t-butyl-4-hydroxyphenyl)propionate], 2,2′-methylenebis(4-methyl-t-butylphenol), triethyleneglycol bis [3-(3 -t-butyl-5-methyl-4-hydroxyphenyl)propionate], tetrakis [methylene-3-(3′,5′-di-t-butyl-4′-hydroxyphenyl)propionate]methane, 3,9-bis [2-{3-(3-t-butyl-4-hydroxy-5-methylphenyl)propionyloxy}-1,1-dimethylethyl]2,4,8,10-tetraoxaspiro(5,5)undecane, N,N′-bis-3-(3′,5′-di-t-butyl-4′-hydroxyphenyl)propionylhexamethylenediamine, N,N′-tetramethylenebis-3-(3′-methyl-5′-t-butyl-4′-hydroxyphenol)propionyldiamine, N,N′-bis-[3-(3,5-di-t-butyl -4-hydroxyphenol)propionyl]hydrazine, N-salicyloyl-N′-salicylidenehydrazine, 3-(N-salicyloyl)amino-1,2,4-triazole, N,N′-bis[2-{3-(3,5-di-t-butyl-4-hydroxyphenyl)propionyloxy}ethyl]oxyamide, pentaerythrityl tetrakis [3-(3,5-di-t-butyl-4-hydroxyphenyl)propionate], N,N′-hexamethylenebis(3,5-di-t-butyl-4-hydroxy-hydrocinnamide), and the like. Triethyleneglycolbis [3-(3-t-butyl-5-methyl-4-hydroxyphenyl)propionate], tetrakis[methylene-3-(3′,5′-di-t-butyl-4′-hydroxyphenyl)propionate]methane, 1,6-hexanediol bis[3-(3,5-di-t-butyl-4-hydroxyphenyl)propionate], pentaerythrityl tetrakis [3-(3,5-di-t-butyl-4-hydroxyphenyl)propionate, and N,N′-hexamethylenebis(3,5-di-t-butyl-4-hydroxy-hydrocinnamide) are preferred. Examples of specific trade names of hindered phenol compounds include “ADK STAB” (registered trademark) AO-20, AO-30, AO-40, AO-50, AO-60, AO-70, AO-80, AO-330, manufactured by ADEKA Corporation, “Irganox” (registered trademark) 245, 259, 565, 1010, 1035, 1076, 1098, 1222, 1330, 1425, 1520, 3114, 5057, manufactured by Ciba Specialty Chemicals, “SUMILIZER” (registered trademark) BHT-R, MDP-S, BBM-S, WX-R, NW, BP-76, BP-101, GA-80, GM, GS, manufactured by Sumitomo Chemical Co., Ltd., and “Cyanox” CY-1790, manufactured by Cyanamid.

Examples of thioether compounds include dilauryl thiodipropionate, ditridecyl thiodipropionate, dimyristyl thiodipropionate, distearyl thiodipropionate, pentaerythritol tetrakis(3-laurylthiopropionate), pentaerythritol tetrakis(3 -dodecylthiopropionate), pentaerythritol tetrakis(3-octadecylthiopropionate), pentaerythritol tetrakis(3-myristylthiopropionate), pentaerythritol tetrakis(3-stearylthiopropionate).

Among them, a thioether compound is more preferred in terms of improving the mechanical properties.

The blending amount of the antioxidant (C) is preferably 0.01 to 1 part by weight with respect to 100 parts by weight of the thermoplastic polyester resin (A). The resistance to oxidative degradation can be improved when the blending amount of the antioxidant (C) is 0.01 parts by weight or more. The blending amount is more preferably, 0.02 parts by weight or more, and still more preferably, 0.03 parts by weight or more. On the other hand, the mechanical properties can be improved more when the blending amount of the antioxidant (C) is 1 part by weight or less. The blending amount is more preferably, 0.5 parts by weight or less, and still more preferably, 0.3 parts by weight or less.

The resin composition may include one or more arbitrary additives such as an ultraviolet absorber, a photostabilizer, a plasticizer and an antistatic agent, to the extent that the desired effect is not impaired.

The resin composition may also include a thermoplastic resin other than the component (A), to improve the moldability, dimensional accuracy, mold shrinkage and toughness of the resin composition and the resulting molded article, to the extent that the desired effect is not impaired. Examples of the thermoplastic resin other than the component (A) include: polyolefin resins, polyvinyl resins, polyamide resins, polyacetal resins, polyurethane resins, aromatic polyketone resins, aliphatic polyketone resins, polyphenylene sulfide resins, polyether ether ketone resins, polyimide resins, thermoplastic starch resins, polyurethane resins, aromatic polycarbonate resins, polyaryl ate resins, polysulfone resins, polyethersulfone resins, phenoxy resins, polyphenylene ether resins, poly-4-methylpentene-1, polyetherimide resins, cellulose acetate resins, polyvinyl alcohol resins, thermoplastic polyester resins which do not have a melting point of 180 to 250° C. and the like. Specific examples of the above-mentioned olefin resins include ethylene/propylene copolymers, ethylene/propylene/nonconjugated diene copolymers, ethylene-butene-1 copolymers, ethylene/glycidyl methacrylate, ethylene/butene-1/maleic anhydride, ethylene/propylene/maleic anhydride, ethylene/maleic anhydride and the like. Moreover, specific examples of the above-mentioned vinyl resins include vinyl (co)polymers such as methyl methacrylate/styrene resins (MS resins), methyl methacrylate/acrylonitrile, polystyrene resins, acrylonitrile/styrene resins (AS resins), styrene/butadiene resins, styrene/N-phenylmaleimide resins, and styrene/acrylonitrile/N-phenylmaleimide resins; styrene-based resins modified with a rubbery polymer such as acrylonitrile/butadiene/styrene resins (ABS resins), acrylonitrile/butadiene/methyl methacrylate/styrene resins (MABS resins), and high impact polystyrene resins; block copolymers such as styrene/butadiene/styrene resins, styrene/isoprene/styrene resins, and styrene/ethylene/butadiene/styrene resins; and still more, as core shell rubbers, multilayer structures of dimethylsiloxane/butyl acrylate (core layer) and methyl methacrylate polymer (shell layer), multilayer structures of dimethylsiloxane/butyl acrylate (core layer) and acrylonitrile/styrene copolymer (shell layer), multilayer structures of butadiene/styrene polymer (core layer) and methyl methacrylate polymer (shell layer), and multilayer structures of butadiene/styrene polymer (core layer), acrylonitrile/styrene copolymer (shell layer), and the like.

The resin composition can include a polyol compound containing one or more alkylene oxide units having three or more functional groups (It may be hereinafter referred to as “polyol compound”). Incorporation of such a compound improves flowability during molding such as injection molding. As used herein, the polyol compound refers to a compound containing two or more hydroxyl groups. The polyol compound may be a low-molecular weight compound or a polymer. The functional group other than a hydroxy group includes an aldehyde group, a carboxylic acid group, a sulfo group, an amino group, a glycidyl group, an isocyanate group, a carbodiimide group, an oxazoline group, an oxazine group, an ester group, an amide group, a silanol group, a silyl ether group, and the like. It is preferred to have, among these, three or more of the same or different functional groups. It is more preferred to have three or more of the same functional groups, particularly in terms of further improving the flowability, mechanical properties, durability, heat resistance and productivity.

Preferred examples of the alkylene oxide unit include aliphatic alkylene oxide units having from 1 to 4 carbon atoms. Specific examples thereof include a methylene oxide unit, an ethylene oxide unit, a trimethylene oxide unit, a propylene oxide unit, a tetramethylene oxide unit, a 1,2-butylene oxide unit, a 2,3-butylene oxide unit, an isobutylene oxide unit and the like.

In particular, it is preferred that a compound containing an ethylene oxide unit or a propylene oxide unit as the alkylene oxide unit be used, in terms of improving the flowability, recycling properties, durability, heat resistance and mechanical properties. Further, it is particularly preferred that a compound containing a propylene oxide unit is used, in terms of improving the long-term hydrolysis resistance and toughness (tensile elongation at break). The number of the alkylene oxide unit per one functional group is preferably 0.1 or more, more preferably, 0.5 or more, and still more preferably, 1 or more, in terms of improving the flowability. On the other hand, in terms of improving the mechanical properties, the number of the alkylene oxide unit per one functional group is preferably 20 or less, more preferably, 10 or less, and still more preferably, 5 or less.

In addition, the polyol compound may be reacted with the thermoplastic polyester resin (A) to be introduced into the main chain and/or side chains of the component (A), or alternatively, the polyol compound may exist, as it is, in the resin composition, without reacting with the component (A).

The blending amount of the polyol compound is preferably 0.01 to 3 parts by weight, and more preferably, 0.1 to 1.5 parts by weight with respect to 100 parts by weight of the thermoplastic polyester resin (A).

The resin composition can further include a flame retardant (E), to the extent that the desired effect is not impaired. The flame retardants (E) include, for example, a phosphorus-based flame retardant, a halogen-based flame retardant such as a bromine-based flame retardant, a salt of a triazine compound and cyanuric acid or isocyanuric acid, a silicone-based flame retardant, an inorganic flame retardant and the like. Two or more of these may be included.

The blending amount of the flame retardant (E) is preferably 1 to 100 parts by weight with respect to 100 parts by weight of the thermoplastic polyester resin (A).

Examples of the phosphorus-based flame retardant include aromatic phosphate ester compounds, phosphazene compounds, phosphaphenanthrene compounds, metal phosphinates, ammonium polyphosphates, melamine polyphosphates, phosphate amides, red phosphorus, and the like. Among these, an flame retardant selected from an aromatic phosphate ester compound, a phosphazene compound, a phosphaphenanthrene compound, and a metal phosphinate is preferably used.

Examples of the aromatic phosphate ester compound include resorcinol diphenyl phosphate, hydroquinone diphenyl phosphate, bisphenol A diphenyl phosphate, biphenyl diphenyl phosphate, and the like. Examples of the commercially available product thereof include PX-202, CR-741, PX-200, and PX-201, manufactured by Daihachi Chemical Industry Co., Ltd.; and FP-500, FP-600, FP-700 and PFR, manufactured by ADEKA Corporation and the like.

The phosphazene compound may be, for example, a phosphonitrile linear polymer and/or cyclic polymer. In particular, the compound comprising a linear phenoxyphosphazene as a major component is preferably used. The phosphazene compound can be synthesized by a generally known method disclosed, for example, in “Hosufazen Kagobutsu No Gosei To Oyo (Synthesis and Application of Phosphazene Compounds)” by Kajiwara. For example, the phosphazene compound can be synthesized by reacting phosphorus pentachloride or phosphorus trichloride as a phosphorus source with ammonium chloride or ammonia gas as a nitrogen source, using a known method (or by purifying a cyclic product), and then by subjecting the resulting substance to a substitution reaction with an alcohol, a phenol or an amine. As the commercially available product of the phosphazene compound, “Rabitle” (registered trademark) FP-110, manufactured by Fushimi Pharmaceutical Co., Ltd.; SPB-100 manufactured by Otsuka Chemical Co., Ltd. and the like are preferably used.

The phosphaphenanthrene compound is a phosphorus-based flame retardant containing at least one phosphaphenanthrene skeleton within its molecule. The examples of the commercially available product thereof include HCA, HCA-HQ, BCA, SANKO-220 and M-Ester, manufactured by Sanko Co., Ltd.; and the like. In particular, M-Ester is preferably used, because the reaction between its terminal hydroxyl groups and the terminal of the thermoplastic polyester resin (A) can be expected during melt blending, and thus is effective for preventing the occurrence of bleed-out under high-temperature and high-humidity conditions.

The metal phosphinate is a phosphinate and/or a diphosphinate and/or a polymer thereof, and it is a compound useful as a flame retardant for the thermoplastic polyester resin (A). Examples of the salt include salts of calcium, aluminum, zinc and the like. Examples of the commercially available product of the metal phosphinate include “Exolit” (registered trademark) OP1230 and OP1240, manufactured by Clariant Japan K. K. and the like.

The phosphate amide is an aromatic amide-based flame retardant containing a phosphorus atom and a nitrogen atom. Since the phosphate amide is a substance with a high melting point which is in the form of a powder at normal temperature, it has an excellent handleability during blending, and is capable of improving the heat distortion temperature of the resulting molded article. As the commercially available product of the phosphate amide, SP-703 manufactured by Shikoku Chemicals Corporation is preferably used.

Examples of the ammonium polyphosphate include ammonium polyphosphate, melamine-modified ammonium polyphosphate, ammonium carbamylpolyphosphate and the like. The ammonium polyphosphate may be coated with a thermosetting resin such as a phenol resin, a urethane resin, a melamine resin, a urea resin, an epoxy resin, or a urea resin, which exhibits thermosetting properties.

Examples of the melamine polyphosphate include melamine phosphate, melamine pyrophosphate, and other melamine polyphosphates such as phosphate with melamine, melam or melem. Preferred examples of the commercially available product of the melamine polyphosphate include “MPP-A” manufactured by Sanwa Chemical Co., Ltd.; PMP-100 and PMP-200 manufactured by Nissan Chemical Industries, Ltd. and the like.

As the red phosphorus, red phosphorus treated with a compound film(s) such as a thermosetting resin film, a metal hydroxide film, and/or a metal plating film is preferred. Examples of the thermosetting resin for the thermosetting resin film include phenol-formalin resins, urea-formalin resins, melamine-formalin resins, alkyd resins and the like. Examples of the metal hydroxide for the metal hydroxide film include aluminum hydroxide, magnesium hydroxide, zinc hydroxide, titanium hydroxide and the like. Examples of the metal to be used for the metal plating film include Fe, Ni, Co, Cu, Zn, Mn, Ti, Zr, Al, and alloys thereof. These films may be composed of two or more of the above mentioned components, or may be a laminate of two or more layers.

The blending amount of the phosphorus-based flame retardant is preferably 1 to 40 parts by weight, and more preferably 10 to 24 parts by weight with respect to 100 parts by weight of the thermoplastic polyester resin (A).

Specific examples of the bromine-based flame retardant include: decabromodiphenyl oxide, octabromodiphenyl oxide, tetrabromodiphenyl oxide, tetrabromophthalic anhydride, hexabromocyclododecane, bis(2,4,6-tribromophenoxy)ethane, ethylene bistetrabromophthalimide, hexabromobenzene, 1,1-sulfonyl [3,5-dibromo-4-(2,3-dibromopropoxy)]benzene, polydibromophenylene oxide, tetrabromobisphenol-S, tris(2,3-dibromopropyl-1)isocyanurate, tribromophenol, tribromophenyl allyl ether, tribromoneopentyl alcohol, brominated polystyrene, brominated polyethylene, tetrabromobisphenol-A, tetrabromobisphenol-A derivatives, tetrabromobisphenol-A-epoxy oligomers and polymers, tetrabromobisphenol-A-carbonate oligomers and polymers, brominated epoxy resins such as brominated phenol novolac epoxy, tetrabromobisphenol-A-bis(2-hydroxydiethyl ether), tetrabromobisphenol-A-bis(2,3-dibromopropyl ether), tetrabromobisphenol-A-bis(allyl ether), tetrabromocyclooctane, ethylene bispentabromodiphenyl, tris(tribromoneopentyl)phosphate, poly(pentabromobenzyl polyacrylate), octabromotrimethylphenyl indan, dibromoneopentyl glycol, pentabromobenzyl polyacrylate, dibromocresyl glycidyl ether, N,N′-ethylene-bis-tetrabromophthalimide and the like. Among these, a tetrabromobisphenol-A-epoxy oligomer, a tetrabromobisphenol-A-carbonate oligomer and a brominated epoxy resin are preferably used.

The blending amount of the halogen-based flame retardant is preferably 1 to 50 parts by weight, and more preferably 3 to 40 parts by weight with respect to 100 parts by weight of the thermoplastic polyester resin (A).

As the salt of a triazine compound and cyanuric acid or isocyanuric acid, melamine cyanurate and melamine isocyanurate are preferably used. A salt of a triazine compound and cyanuric acid or isocyanuric acid, having a molar ratio of 1:1, is commonly used and, in some cases, a salt having a molar ratio of 1:2 may be used. The incorporation of such a compound serves to further improve the flame retardancy of the resin composition and the resulting molded article, by its cooling effect.

The melamine cyanurate or the melamine isocyanurate can be produced by an arbitrary method. For example, a mixture of melamine and cyanuric acid or isocyanuric acid is formed into a water slurry, and after sufficiently mixing the slurry to produce their salt in the form of microparticles, the resulting slurry is filtered and dried to obtain the desired product, generally, in the form of a powder. The above mentioned salt does not have to be completely pure, and some melamine, or some cyanuric acid or isocyanuric acid may remain unreacted. Further, a dispersant such as tris(β-hydroxyethyl)isocyanurate or a known surface treating agent such as polyvinyl alcohol and a metal oxide such as silica may be used to improve the dispersibility. The melamine cyanurate or the melamine isocyanurate preferably has an average particle size of 0.1 to 100 μm, and more preferably 0.3 to 10 μm at both before and after being added to the resin, in terms of the flame retardancy, mechanical strength and surface properties of the molded article. The average particle size as used herein is a particle size corresponding to 50% of the cumulative distribution, as measured using a laser micron sizer. As the commercially available product of the salt of a triazine compound and cyanuric acid or isocyanuric acid, MC-4000, MC-4500 and MC-6000 manufactured by Nissan Chemical Industries, Ltd. and the like are preferably used.

The blending amount of the salt of a triazine compound and cyanuric acid or isocyanuric acid is preferably 1 to 50 parts by weight, and more preferably 10 to 45 parts by weight with respect to 100 parts by weight of the thermoplastic polyester resin (A) in terms of the flame retardancy and mechanical properties.

Examples of the silicone-based flame retardant include silicone resins and silicone oils. Examples of the silicone resin include resins having a three dimensional network structure formed by combining structural units such as SiO₂, RSiO_{3/2}, R₂SiO and R₃SiO_{1/2} and the like; wherein R represents an optionally substituted alkyl group or an aromatic hydrocarbon group. The alkyl groups include a methyl group, an ethyl group, a propyl group and the like; and the aromatic hydrocarbon groups include a phenyl group, a benzyl group and the like. The substituent groups include a vinyl group and the like.

Examples of the silicone oil include polydimethylsiloxane; and modified polysiloxanes obtained by modifying at least one of the methyl groups on the side chains or terminals of the polydimethylsiloxane with at least one group selected from the group consisting of a hydrogen, an alkyl group, a cyclohexyl group, a phenyl group, a benzyl group, an amino group, an epoxy group, a polyether group, a carboxyl group, a mercapto group, a chloroalkyl group, an alkyl higher alcohol ester group, an alcohol group, an aralkyl group, a vinyl group and a trifluoromethyl group and the like.

Examples of the inorganic flame retardant include magnesium hydroxide hydrate, aluminum hydroxide hydrate, antimony trioxide, antimony pentoxide, sodium antimonate, zinc hydroxystannate, zinc stannate, metastannic acid, tin oxide, tin oxide salt, zinc sulfate, zinc oxide, zinc borate, zinc borate hydrate, zinc hydroxide ferrous oxide, ferric oxide, sulfur sulfide, stannous oxide, stannic oxide, ammonium borate, ammonium octamolybdate, metal tungstates, complex acidic oxides of tungsten with metalloid, ammonium sulfamate, zirconium compounds, graphite, expansive graphite and the like.

The inorganic flame retardant may be surface treated with a fatty acid or a silane coupling agent. Among the inorganic flame retardants, zinc borate hydrate and expansive graphite are preferred in view of the flame retardancy, and a flame retardant selected from magnesium oxide/aluminum oxide mixture, zinc stannate, metastannic acid, tin oxide, zinc sulfate, zinc oxide, zinc borate, zinc ferrous oxide, ferric oxide and sulfur sulfide is particularly preferred for the excellent flame retardancy and retention stability.

The blending amount of the inorganic flame retardant is preferably 0.05 to 4 parts by weight or more, and more preferably 0.15 to 2 parts by weight or more with respect to 100 parts by weight of the thermoplastic polyester resin (A), in terms of exerting the endothermic effect of combustion heat and the effect of expanding to prevent combustion.

The resin composition can include a fluororesin. Incorporation of the fluororesin serves to prevent melt dripping during combustion and improve flame retardancy.

The fluororesin is a resin containing fluorine in its molecule. Specific examples thereof include polytetrafluoroethylene, polyhexafluoropropylene, (tetrafluoroethylene/hexafluoropropylene) copolymers, (tetrafluoroethylene/perfluoroalkyl vinyl ether) copolymers, (tetrafluoroethylene/ethylene) copolymers, (hexafluoropropylene/propylene) copolymers, polyvinylidene fluoride, (vinylidene fluoride/ethylene) copolymers and the like.

Among these, polytetrafluoroethylene, a (tetrafluoroethylene/perfluoroalkyl vinyl ether) copolymer, a (tetrafluoroethylene/hexafluoropropylene) copolymer, a (tetrafluoroethylene/ethylene) copolymer, and polyvinylidene fluoride are preferred, and polytetrafluoroethylene and a (tetrafluoroethylene/ethylene) copolymer are particularly preferred.

The blending amount of the fluororesin is preferably 0.05 to 3 parts by weight, and more preferably 0.15 to 1.5 parts by weight with respect to 100 parts by weight of the thermoplastic polyester resin (A).

The resin composition can include a mold release agent. By including the mold release agent, the releasability during injection molding can be improved. Examples of the mold release agent include known mold release agents for plastic materials, for example, a fatty acid amide such as ethylene bisstearylamide; a fatty acid amide comprising a polycondensate of ethylenediamine with stearic acid and sebacic acid or a polycondensate of phenylenediamine with stearic acid and sebacic acid; a polyalkylene wax, an acid anhydride-modified polyalkylene wax, and a mixture of the above mentioned lubricant with a fluororesin or fluorine-based compound.

The blending amount of the mold release agent is preferably 0.01 to 1 part by weight, and more preferably 0.03 to 0.6 parts by weight with respect to 100 parts by weight of the thermoplastic polyester resin (A).

The resin composition can further include a reinforcing fiber (D), to the extent that the desired effect is not impaired. Incorporation of the reinforcing fiber (D) further improves the mechanical strength and heat resistance.

Specific examples of the reinforcing fiber (D) include glass fibers, aramid fibers, carbon fibers and the like. As the glass fiber, a chopped strand-type or a robing-type glass fiber, treated with a silane coupling agent such as aminosilane compounds and epoxysilane compounds, and/or a sizing agent such as urethanes, vinyl acetates, bisphenol A diglycidyl ether and epoxy compounds including one or more kinds of novolac epoxy compounds, is preferably used. A silane coupling agent and/or a sizing agent may be used being mixed in emulsion liquid. The reinforcing fiber usually has a fiber diameter of 1 to 30 μm, and preferably 5 to 15 μm. Though fiber cross section is usually circular, it is possible to use a reinforcing fiber with an arbitrary cross section, for example, a glass fiber with an elliptic cross section, a glass fiber with a flattened elliptic cross section, and a glass fiber with a dumbbell-shaped cross section, of an arbitrary aspect ratio and such a reinforcing fiber allows for improving the flowability during injection molding, and for producing a molded article with less warpage.

The blending amount of the reinforcing fiber (D) is preferably 1 to 100 parts by weight, and more preferably 3 to 95 parts by weight with respect to 100 parts by weight of the thermoplastic polyester resin (A).

The resin composition can include an inorganic filler other than the reinforcing fiber. Incorportion of the inorganic filler other than the reinforcing fiber serves to partially improve the crystallization characteristics, arc resistance, anisotropy, mechanical strength, flame retardancy or heat distortion temperature of the resulting molded article, and especially a molded article with less warpage can be produced because of the effect in reducing anisotropy.

Examples of the inorganic filler other than the reinforcing fiber include inorganic fillers in the form of needles, granules, powders and layers. Specific examples thereof include glass beads, milled fibers, glass flakes, potassium titanate whiskers, calcium sulfate whiskers, wollastonite, silica, kaolin, talc, calcium carbonate, zinc oxide, magnesium oxide, aluminum oxide, a mixture of magnesium oxide and aluminum oxide, silicic acid fine powder, aluminum silicate, silicon oxide, smectite clay minerals (montmorillonite, hectorite and the like) vermiculite, mica, fluorine taeniolite, zirconium phosphate, titanium phosphate, dolomite and the like. Two or more of these may be included. The use of milled fibers, glass flakes, kaolin, talc and/or mica allows for providing a molded article with less warpage because they are effective in reducing anisotropy. Further, when calcium carbonate, zinc oxide, magnesium oxide, aluminum oxide, a mixture of magnesium oxide and aluminum oxide, silicic acid fine powder, aluminum silicate and/or silicon oxide are/is included in an amount of 0.01 to 1 part by weight with respect to 100 parts by weight of the thermoplastic polyester resin (A), the retention stability can further be improved.

The inorganic filler other than the reinforcing fiber may be surface treated with a coupling agent, an epoxy compound, or by ionization. The inorganic filler in the form of granules, powders and layers preferably have an average particle size of 0.1 to 20 μm, and more preferably 0.2 to 10 μm, in terms of improving the impact strength. The blending amount of the inorganic filler other than the reinforcing fiber is preferably 1 to 50 parts by weight with respect to 100 parts by weight of the thermoplastic polyester resin (A). When the blending amount of the reinforcing fiber and the inorganic filler other than the reinforcing fiber are used in combination, the total blending amount thereof, is preferably 100 parts by weight or less with respect to 100 parts by weight of the thermoplastic polyester resin (A), in terms of improving the flowability during molding and the durability of the molding machine and mold.

The resin composition can further include one or more of carbon black, titanium oxide and various types of color pigments and dyes. By including such a pigment or dye, it is possible to adjust the color of the resin composition and the resulting molded article to various types of colors, and to improve the weatherability (light resistance) and electrical conductivity thereof. Examples of the carbon black include channel black, furnace black, acetylene black, anthracene black, lamp black, soot of burnt pine, graphite and the like. The carbon black to be used preferably has an average particle size of 500 nm or less, and a dibutyl phthalate oil absorption of 50 to 400 cm³/100 g. As the titanium oxide, one having a rutile-type or anatase-type crystalline structure, and an average particle size of 5 μm or less is preferably used.

The carbon black, titanium oxide and various types of color pigments and dyes may be surface-treated with aluminum oxide, silicon oxide, zinc oxide, zirconium oxide, a polyol, a silane coupling agent or the like, and used in the form of a mixture obtained by melt blending, or by simply blending with various types of thermoplastic resins to improve the dispersibility in the resin composition, and the handleability during the production.

The blending amount of the pigment and dye is preferably 0.01 to 3 parts by weight, and more preferably 0.03 to 1 part by weight with respect to 100 parts by weight of the thermoplastic polyester resin (A).

The resin composition can be obtained, for example, (1) by melt blending the component (A), component (B) and optionally other components, or (2) by adding the component (B) and optionally other components during a production of the component (A). The method (1) is more preferred in terms of improving dispersibility of metal halide (B).

Examples of the method (1) mentioned above include: a method in which the thermoplastic polyester resin (A), the metal halide (B), and optionally the antioxidant (C), and various types of additives are premixed, and the resulting mixture is then fed to an extruder or the like to be sufficiently melt blended; a method in which a specified amount of each of the components is fed to an extruder or the like, using a metering feeder such as a weight feeder, to be sufficiently melt blended and the like.

The premixing can be carried out, for example, by dry blending; or by utilizing a mechanical mixing apparatus such as a tumble mixer, a ribbon mixer or a Henschel mixer. Alternatively, the reinforcing fiber and the inorganic filler other than the reinforcing fiber may be fed through a side feeder installed between the feeding portion and the vent portion of a multi-screw extruder such as a twin-screw extruder. When a liquid additive is used, the additive may be fed, for example, through a liquid feeding nozzle installed between the feeding portion and the vent portion of a multi-screw extruder such as a twin-screw extruder, using a plunger pump; or through the feeding portion or the like, using a metering pump.

When melt blending is carried out using an extruder and the like, it is preferred to use a twin-screw extruder as a melt blending apparatus, and it can improve more dispersibility of metal halide (B) by the shear in the twin-screw extruder.

As a configuration of a twin-screw extruder, a combination of a full flight and a kneading disc is commonly used. Blending homogeneously by a screw is preferred in view of allowing metal halide (B) to be dispersed to have the above-mentioned area average particle size. Therefore, the ratio of the total length of kneading discs (a length of kneading zone) to the full length of the screw is preferably 5 to 50%, and more preferably 10 to 40%.

Examples of the above-mentioned method (2) include a method in which the metal halide (B), and optionally an antioxidant (C), various kinds of additives and the like are added when an esterification or transesterification reaction of a dicarboxylic acid or an ester-forming derivative thereof and a diol or an ester-forming derivative thereof is carried out.

It is preferred that the resin composition be formed into pellets, and then the pellets be subjected to molding processing. The formation of pellets can be carried out, for example, by extruding the resin composition in the form of strands using a single-screw extruder, a twin-screw extruder, a triple-screw extruder, a conical extruder or a kneader-type mixer, equipped with “Uni-melt” or “Dulmage” type screw, and then by cutting the resulting strands using a strand cutter.

By melt-molding the resin composition, it is possible to obtain a molded article in the form of a film, fiber, and other various types of shapes. Examples of the melt-molding method include methods such as injection molding, extrusion molding, blow molding and the like. Injection molding is particularly preferably used.

In addition to a regular injection molding method, other types of injection molding methods are also known such as gas assisted molding, two-color molding, sandwich molding, in-mold molding, insert molding, injection press molding and the like, and the resin composition can be prepared using any of the methods.

The molded article can be used as molded articles for mechanical machine parts, electric components, electronic components and automotive parts, utilizing its excellent mechanical properties such as long-term resistance to oxidative degradation, tensile strength and elongation, and excellent heat resistance. The molded article is useful particularly as outer layer components because of its excellent long-term hydrolysis resistance.

Specific examples of the mechanical machine parts, electric components, electronic component and automotive parts include: breakers, electromagnetic switches, focus cases, flyback transformers, molded articles for fusers of copying machines and printers, general household electrical appliances, housings of office automation devices, parts of variable capacitor case, various types of terminal boards, transformers, printed wiring boards, housings, terminal blocks, coil bobbins, connectors, relays, disk drive chassis, transformers, switch parts, wall outlet parts, motor components, sockets, plugs, capacitors, various types of casings, resistors, electric and electronic components into which metal terminals and conducting wires are incorporated, computer-related components, audio components such as acoustic components, parts of lighting equipment, telegraphic communication equipment-related components, telephone equipment-related components, components of air conditioners, components of consumer electronics such as VTR and TV, copying machine parts, facsimile machine parts, components of optical devices, components of automotive ignition system, connectors for automobiles, various types of automotive electrical components and the like.

### EXAMPLES

The thermoplastic polyester resin composition will now be described specifically, by way of Examples. Raw materials to be used in the Examples and Comparative Examples will be shown below. Note that, all “%” and “part(s)” as used herein represent “% by weight” and “part(s) by weight,” respectively.

### Thermoplastic Polyester Resin (A)

<A-1> Polybutylene terephthalate resin: a polybutylene terephthalate resin (Melting point 225° C., Weight average molecular weight 18,000), manufactured by Toray Industries, Inc., was used.
<A-2> Polyethylene terephthalate resin: a polyethylene terephthalate resin (Melting point 260° C., Weight average molecular weight 19,000), manufactured by Toray Industries, Inc., was used.
<A-3> Polybutylene terephthalate resin: a polybutylene terephthalate resin (Melting point 225° C., Weight average molecular weight 50,000), manufactured by Toray Industries, Inc., was used.

### Metal Halide (B)

<B-1> Potassium iodide: Potassium iodide (reagent) manufactured by Wako Pure Chemical Industries, Ltd. was used.
<B-2> Sodium iodide: Sodium iodide (reagent) manufactured by Tokyo Chemical Industry Co., Ltd. was used.
<B-3> Lithium iodide: Lithium iodide (reagent) manufactured by Wako Pure Chemical Industries, Ltd. was used.
<B-4> Potassium bromide: Potassium bromide (reagent) manufactured by Tokyo Chemical Industry Co., Ltd. was used.
<B-5> Copper(I) iodide: Copper (I) iodide (reagent) manufactured by Wako Pure Chemical Industries, Ltd. was used.

### Antioxidant (C)

<C-1> Pentaerythritol tetrakis(3-dodecylthiopropionate): manufactured by ADEKA Corporation, “ADK STAB” (registered trademark) AO-412S was used.

### Reinforcing Fiber (D)

<D-1> Glass fiber: a chopped strand-type glass fiber with a fiber diameter of about 10 μm 3J948 manufactured by Nitto Boseki Co., Ltd., was used.

### Methods of Measuring Properties

In the Examples and Comparative Examples, selected properties were evaluated according to the following measurement methods.

### 1. Average Particle Size

The ASTM No. 4 dumbbell-shaped test specimens having a thickness of 1/25 inch (about 1.0 mm) were obtained using an injection molding machine, IS55EPN, manufactured by Toshiba Machine Co., Ltd., in the temperature conditions of a molding temperature of 250° C. and a mold temperature of 80° C. when a polybutylene terephthalate resin was used as the component (A); and in the temperature conditions of a molding temperature of 285° C., and a mold temperature of 80° C. when a polyethylene terephthalate resin was used as the component (A), and in the molding cycle condition with 10 seconds of the total of injection and retention times and 10 seconds of cooling time. The ASTM No. 1 dumbbell-shaped test specimens having a thickness of ⅛ inch (about 3.2 mm) were obtained in the same molding cycle condition as mentioned above when glass fibers were included in the thermoplastic polyester resin composition. The cross section of the resulting specimens were then observed for a dispersion state of metal halide (B) using a transmission electron microscope (TEM). After a section having a thickness of 100 μm was cut out of an injection molded article and the component (A) in the section was then stained by iodine staining, the section was observed at the magnification of 100,000 times with the transmission electron microscope for the sample of which the ultra-thin section was cut out. At least 100 particles made of metal halide (B) was observed to determine the area average particle size.

### 2. Melt Retention Stability

2.0 g of the resin composition was weighed on an aluminum dish and then heat-treated for 2 hours in a Geer oven under an atmospheric pressure. The heating temperature was 250° C. when a polybutylene terephthalate resin was used as the component (A) and 285° C. when a polyethylene terephthalate resin was used as the component (A). A solution obtained by dissolving the heat-treated resin composition in a mixed solution of o-cresol/chloroform (2/1 vol) was titrated with 0.05 mol/L ethanolic potassium hydroxide, using 1% bromophenol blue as an indicator, and the concentration of the carboxyl end groups was calculated by the following equation. Blue (color D55-80 (2007 D Edition, Pocket-type, published by Japan Paint Manufacturers Association)) was used as the end point of the titration.
The concentration of the carboxyl end groups [eq/t]=(the amount of 0.05 mol/L ethanolic potassium hydroxide [ml] required for the titration of the mixed solution of o-cresol/chloroform (2/1 vol) in which the component (A) is dissolved−the amount of 0.05 mol/L ethanolic potassium hydroxide [ml] required for the titration of the mixed solution of o-cresol/chloroform (2/1 vol))×the concentration of 0.05 mol/L ethanolic potassium hydroxide [mol/ml]×1/the component (A) amount taken [g] used in the titration.

The concentration of the carboxyl end groups derived from the component (A) in the thermoplastic polyester resin composition was calculated according to the following equation, from the concentration of the carboxyl end groups in the thermoplastic polyester resin composition calculated based on the result of the above mentioned titration, and from the blending amount of the component (A) in thermoplastic polyester resin composition.
The concentration [eq/t] of the carboxyl end group in the component (A) in the thermoplastic polyester resin composition=the concentration of the carboxyl end groups in the thermoplastic polyester resin composition×the total amount of the thermoplastic polyester resin composition [parts by weight]/the blending amount of the component (A) [parts by weight].

### 3. Mechanical Property (Tensile Property)

ASTM No. 4 dumbbell-shaped test specimens having a thickness of 1/25 inch (about 1.0 mm) and ASTM No. 1 dumbbell-shaped test specimens having a thickness of ⅛ inch (about 3.2 mm) were prepared using an injection molding machine, IS55EPN, manufactured by Toshiba Machine Co., Ltd., under the same injection molding conditions as described for the preparation of the test specimens for evaluating the tensile properties. The maximum tensile strength point (tensile strength) and the maximum tensile elongation point (tensile elongation) of the resulting test specimens for evaluating the tensile properties were measured, according to ASTM D638 (2005). The mean of the measured values of the three test specimens was taken as the value of the heat distortion temperature. Materials with higher values of tensile strength and the tensile elongation are evaluated to have better toughness.

### 4. Weight Average Molecular Weight Retention

2.5 mg of the resin composition was dissolved into 3 ml of hexafluoroisopropanol and then the mixture was filtered through a Chromatodisc having a pore size of 0.45 μm to obtain a solution of the thermoplastic polyester resin (A). The weight average molecular weight in terms of PMMA of the resulting solution of the thermoplastic polyester resin (A) was calculated using GPC. Measurement by GPC was carried out using a differential refractometer WATERS 410, manufactured by Nihon Waters K.K., as a detector, high performance liquid chromatography MODEL 510 as a pump, and a column connected in series with Shodex GPC HFIP-806M and Shodex GPC HFIP-LG. As the measurement condition, the flow rate was 1.0 mL/minute and the injection amount was 0.1 mL. This was defined as the weight average molecular weight before heat-treating.

Next, on the condition that a press temperature was 250° C. when a polybutylene terephthalate resin as the component (A) is used, and a press temperature was 280° C. when a polyethylene terephthalate resin as the component (A) is used, the resin composition was heat-treated for 5 minutes using a hot press and crystallized at 110° C. for 5 minutes to obtain a test pressed sheet having a thickness of 600 μm. After the test pressed sheet obtained was heat-treated at 180° C. for 250 hours in a Geer oven under an atmospheric pressure, 2.5 mg of the test pressed sheet was dissolved in 3 ml of hexafluoroisopropanol and filtered through a Chromatodisc having a pore size of 0.45 μm to obtain a solution of the thermoplastic polyester resin (A). The weight average molecular weight of the thermoplastic polyester resin (A) after heat-treating was then measured by the same way as that before heat-treating. The weight average molecular weight retention was calculated with the weight average molecular weight after heat-treating being divided by the weight average molecular weight before heat-treating and being multiplied with 100.

5. Peak Integral at the Chemical Shift from 5.2 to 6.0 ppm in ¹H-NMR Spectrum

In 1 ml of deuterated hexafluoroisopropanol, 10 mg of the test pressed sheet, which was heat-treated at 180° C. for 250 hours in a Geer oven under an atmospheric pressure as above, was dissolved and used as a test sample. The measurement was carried out using a NMR spectrometer UNITY INOVA 500, manufactured by Varian Inc., in the condition of an observed nuclear of ¹H, a standard of TMS, an observed frequency of 125.7 MHz, a scanning time of 6,000, and a temperature of 15° C. The peak integral from 5.2 to 6.0 ppm was calculated when the peak integral from 3.6 to 4.0 ppm is defined as 100 in the ¹H-NMR spectrum obtained.

### 6. Tensile Strength Retention

ASTM No. 4 dumbbell-shaped test specimens having a thickness of 1/25 inch (about 1.0 mm) and ASTM No. 1 dumbbell-shaped test specimens having a thickness of ⅛ inch (about 3.2 mm), obtained in above, were measured for the maximum tensile strength point (tensile strength) and the maximum tensile elongation point (tensile elongation) after heat-treating at 180° C. for 250 hours in a Geer oven under an atmospheric pressure according to ASTM D638 (2005). The mean of the measured values of the respective three test specimens was taken as the respective value. The tensile strength retention (%) was calculated with the tensile strength after heat-treating being divided by the tensile strength before heat-treating and being multiplied with 100.

### 7. Content of Metal Halide (B)

At the final temperature of 1,000° C., 2 mg of the resin composition was burned and the gas components generated thereby were allowed to be absorbed into 10 mL of water containing an antioxidant of a dilute concentration. For the blending amount of the metal halide (B) in terms of 100 parts by weight of the thermoplastic polyester resin (A), the resulting absorbent was measured by an ion chromatography system ICS 1500 manufactured by DIONEX Corp. using sodium carbonate/sodium bicarbonate mixture solution as mobile phase.

### Examples 1 to 8, Comparative Examples 1 to 6 and 10

Using a co-rotating vent-type twin-screw extruder having a screw diameter of 30 mm, a ratio of kneading zone of 20%, and L/D of 35 (manufactured by Japan Steel Works, LTD., TEX-30α), the polybutylene terephthalate resin (A-1), the metal halide (B) and the antioxidant (C) were admixed according to the compositions shown in Tables 1 and 2, and added through the feeding portion of the twin-screw extruder. Subsequently, melt blending was performed under the extrusion conditions of a kneading temperature of 250° C. and a screw rotational speed of 150 rpm. The resulting resin composition was extruded in the form of strands and passed through a cooling bath, and the resulting strands were then cut into pellets using a strand cutter.

The resulting pellets were dried in a hot air dryer controlled at a temperature of 110° C. for 12 hours. After drying, the dried pellets were evaluated according to the methods mentioned above. The results are shown in Tables 1 and 2.

### Example 9

The ratio of the kneading zone was 0%, in other words, the pellets were obtained in the same way as Example 2, excepting all were only a full flight. The resulting pellets were dried in a hot air dryer controlled at a temperature of 110° C. for 12 hours. After drying, the dried pellets were evaluated according to the methods mentioned above. The results are shown in Table 1.

### Example 10 to 12

(A-1) The pellets were obtained in the same way as Example 2, except that polybutylene terephthalate resin and metal halide (B) were used according to the composition shown in Table 1 and the ratio of the kneading zone was 55%. The resulting pellets were dried in a hot air dryer controlled at a temperature of 110° C. for 12 hours. After drying, the dried pellets were evaluated according to the methods mentioned above. The results are shown in Table 1.

### Comparative Example 7

The pellets were obtained in the same way as Comparative Example 1, except that the thermoplastic polyester resin (A) was (A-2) and that the blending temperature was 285° C. The resulting pellets were dried in a hot air dryer controlled at a temperature of 130° C. for 12 hours. After drying, the dried pellets were evaluated according to the methods mentioned above. The results are shown in Table 2.

### Comparative Example 8

The pellets were obtained in the same way as Example 2, except that the thermoplastic polyester resin (A) was (A-2) and that the blending temperature was 285° C. The resulting pellets were dried in a hot air dryer controlled at a temperature of 130° C. for 12 hours. After drying, the dried pellets were evaluated according to the methods mentioned above. The results are shown in Table 2.

### Examples 13 to 14, Comparative Example 9

Using a co-rotating vent-type twin-screw extruder having a screw diameter of 30 mm, a ratio of kneading zone of 20%, and L/D of 35 (manufactured by Japan Steel Works, LTD., TEX-30α), the polybutylene terephthalate resin (A-1) and the metal halide (B) were admixed according to the compositions shown in Tables 1 and 2, and added through the feeding portion of the twin-screw extruder. The reinforcing fiber (D) was added through a side feeder installed between the feeding portion and the vent portion of the extruder, according to the composition ratios shown in Tables 1 and 2. Melt blending was performed under the extrusion conditions of a kneading temperature of 250° C. and a screw rotational speed of 150 rpm. The resulting resin composition was extruded in the form of strands and passed through a cooling bath, and the resulting strands were then cut into pellets using a strand cutter. The resulting pellets were dried in a hot air dryer controlled at a temperature of 110° C. for 6 hours. After drying, the dried pellets were evaluated according to the above mentioned methods. The results are shown in Tables 1 and 2.

### Example 15

The pellets were obtained in the same way as Example 3, except that the thermoplastic polyester resin (A) was (A-3). The resulting pellets were dried in a hot air dryer controlled at a temperature of 110° C. for 12 hours. After drying, the dried pellets were evaluated according to the methods mentioned above. The results are shown in Table 1.

### Example 16

The pellets were obtained in the same way as Example 4, except that the thermoplastic polyester resin (A) was (A-3). The resulting pellets were dried in a hot air dryer controlled at a temperature of 110° C. for 12 hours. After drying, the dried pellets were evaluated according to the methods mentioned above. The results are shown in Table 1.

### Comparative Example 11

The pellets were obtained in the same way as Example 3, except that the single-screw extruder (manufactured by TANABE PLASTICS MACHINERY CO., LTD., VS40) with the screw diameter of 40 mm, the ratio of kneading zone of 20%, and L/D of 32. The resulting pellets were dried in a hot air dryer controlled at a temperature of 110° C. for 12 hours. After drying, the dried pellets were evaluated according to the methods mentioned above. The results are shown in Table 2.

### Comparative Example 12

The pellets were obtained in the same way as Comparative Example 11, except that the thermoplastic polyester resin (A) was (A-3). The resulting pellets were dried in a hot air dryer controlled at a temperature of 110° C. for 12 hours. After drying, the dried pellets were evaluated according to the methods mentioned above. The results are shown in Table 2.

### Comparative Example 13

One hundred parts by weight of terephthalic acid, 100 parts by weight of 1,4-butanediol and 0.06 parts by weight of tetra-n-butoxy titanate were mixed. The esterification reaction was initiated stirring under a reduced pressure of 87 kPa after melting at 100° C. under a nitrogen atmosphere. Subsequently, the temperature was allowed to rise to 230° C. and the esterification reaction was then carried out at 230° C. The esterification reaction was continued for 240 minutes to obtain bis(hydroxybutyl) terephthalate.

With respect to 100g of the theoretical amount of a polymer obtained by condensation polymerization of bis(hydroxybutyl) terephthalate obtained, 0.02 g of tetra-n-butoxy titanate and 0.1 g of potassium iodide were weighed respectively and the respective 15 times larger quantity of ethylene glycol was added to prepare the mixture, respectively.

After bis(hydroxybutyl) terephthalate was placed in a test tube and melted at 245° C., all the tetra-n-butoxy titanate and potassium iodide mixtures prepared as mentioned above were added, and the pressure then reduced from normal pressure to 80 Pa over 60 minutes and the condensation polymerization allowed to undergo at 245° C. and 80Pa. The torque of a stirring rod of the test tube of interest was monitored and the condensation polymerization was stopped when the torque was achieved to a predetermined torque. After the end of the condensation polymerization, melt was discharged in a strand shape, cooled and then rapidly cut to obtain polyester resin composition pellets including polybutylene terephthalate having a molecular weight of 18,000 (A-4). The resulting pellets were dried in a hot air dryer controlled at a temperature of 110° C. for 6 hours. After drying, the dried pellets were evaluated according to the above mentioned methods. The results are shown in Table 2.

### Comparative Example 14

The pellets were obtained in the same way as Comparative Example 13, except that 0.6 parts by weight of potassium iodide was added. The resulting pellets were dried in a hot air dryer controlled at a temperature of 110° C. for 6 hours. After drying, the dried pellets were evaluated according to the above mentioned methods. The results are shown in Table 2.

TABLE 1

| | | | Example 1 | Example 2 | Example 3 | Example 4 | Example 5 | Example 6 |
|---|---|---|---|---|---|---|---|---|
| Polyester | A-1 | Parts by | 100 | 100 | 100 | 100 | 100 | 100 |
| resin (A) | A-2 | weight | — | — | — | — | — | — |
| | A-3 | | — | — | — | — | — | — |
| Halide | B-1 | Parts by | 0.02 | 0.04 | 0.1 | 0.6 | — | — |
| compound (B) | B-2 | weight | | | | | 0.04 | — |
| | B-3 | | — | — | — | — | — | 0.04 |
| | B-4 | | — | — | — | — | — | — |
| | B-5 | | — | — | — | — | — | — |
| Antioxidant (C) | C-1 | Parts by | — | — | — | — | — | — |
| | | weight | | | | | | |
| Fiber | D-1 | Parts by | — | — | — | — | — | — |
| inforcement (D) | | weight | | | | | | |
| Content of halide compound (B) | | Parts by | 0.019 | 0.039 | 0.098 | 0.57 | 0.036 | 0.037 |
| | | weight | | | | | | |
| Dispersion diameter | Area-average particle size | nm | 12 | 13 | 13 | 19 | 13 | 14 |
| Melt retention | Amount of carboxyl | eq/t | 197 | 132 | 127 | 174 | 130 | 185 |
| Stability | end groups | | | | | | | |
| Mechanical properties | Tensile strength at break | MPa | 54 | 55 | 55 | 51 | 55 | 54 |
| | Tensile elongation at break | % | 175 | 180 | 180 | 134 | 178 | 160 |
| Resistance to | Weight average molecular | ×10,000 | 1.68 | 1.68 | 1.69 | 1.68 | 1.68 | 1.64 |
| oxidative degradation | weight (before treatment) | | | | | | | |
| | Weight average molecular | ×10,000 | 1.46 | 2.05 | 2.16 | 1.88 | 2.15 | 1.33 |
| | weight (after treatment) | | | | | | | |
| | Weight average molecular | % | 87 | 122 | 128 | 112 | 128 | 81 |
| | weight retention | | | | | | | |
| | Peak integral at 5.2 to 6.0 ppm | — | 0.61 | 0.18 | 0.02 | 0.03 | 0.15 | 0.89 |
| | Tensile strength retention | % | 83 | 110 | 114 | 101 | 115 | 80 |
| | | | Example 7 | Example 8 | Example 9 | Example 10 | Example 11 | Example 12 |
| Polyester | A-1 | Parts by | 100 | 100 | 100 | 100 | 100 | 100 |
| resin (A) | A-2 | weight | — | — | — | — | — | — |
| | A-3 | | — | — | — | — | — | — |
| Halide | B-1 | Parts by | — | 0.4 | 0.04 | 0.04 | — | 0.04 |
| compound (B) | B-2 | weight | — | — | — | — | — | — |
| | B-3 | | — | — | — | — | — | — |
| | B-4 | | 0.04 | — | — | — | — | — |
| | B-5 | | — | — | — | — | — | — |
| Antioxidant (C) | C-1 | Parts by | — | — | — | — | 0.04 | 0.04 |
| | | weight | | | | | | |
| Fiber | D-1 | Parts by | — | — | 0.1 | — | — | — |
| inforcement (D) | | weight | | | | | | |
| Content of halide compound (B) | | Parts by | 0.037 | 0.039 | 0.039 | 0.035 | 0.039 | 0.039 |
| | | weight | | | | | | |
| Dispersion diameter | Area-average particle size | nm | 14 | 13 | 52 | 9 | 490 | 320 |
| Melt retention | Amount of carboxyl | eq/t | 185 | 121 | 169 | 172 | 211 | 203 |
| Stability | end groups | | | | | | | |
| Mechanical properties | Tensile strength at break | MPa | 54 | 55 | 54 | 52 | 52 | 52 |
| | Tensile elongation at break | % | 160 | 183 | 175 | 160 | 148 | 157 |
| Resistance to | Weight average molecular | ×10,000 | 1.64 | 1.69 | 1.71 | 1.51 | 1.49 | 1.51 |
| oxidative degradation | weight (before treatment) | | | | | | | |
| | Weight average molecular | ×10,000 | 1.33 | 2.26 | 1.83 | 1.72 | 1.19 | 1.34 |
| | weight (after treatment) | | | | | | | |
| | Weight average molecular | % | 81 | 134 | 107 | 114 | 80 | 89 |
| | weight retention | | | | | | | |
| | Peak integral at 5.2 to 6.0 ppm | — | 0.89 | 0.12 | 0.44 | 0.41 | 0.92 | 0.75 |
| | Tensile strength retention | % | 80 | 119 | 95 | 97 | 80 | 82 |

| | | | Example 13 | Example 14 | Example 15 | Example 16 |
|---|---|---|---|---|---|---|
| Polyester | A-1 | Parts by | 70 | 70 | — | — |
| resin (A) | A-2 | weight | — | — | — | — |
| | A-3 | | — | — | 100 | 100 |
| Halide | B-1 | Parts by | 0.03 | 0.07 | 0.1 | 0.6 |
| compound (B) | B-2 | weight | — | — | — | — |
| | B-3 | | — | — | — | — |
| | B-4 | | — | — | — | — |
| | B-5 | | — | — | — | — |
| Antioxidant (C) | C-1 | Parts by | — | — | — | — |
| | | weight | | | | |
| Fiber | D-1 | Parts by | 30 | 30 | | |
| inforcement (D) | | weight | | | | |
| Content of halide compound (B) | | Parts by | 0.041 | 0.097 | 0.011 | 0.019 |
| | | weight | | | | |
| Dispersion diameter | Area-average particle size | nm | 13 | 13 | 12 | 17 |
| Melt retention | Amount of carboxyl | eq/t | 115 | 108 | 218 | 184 |
| Stability | end groups | | | | | |
| Mechanical properties | Tensile strength at break | MPa | 135 | 136 | 51 | 52 |
| | Tensile elongation at break | % | 3.7 | 3.8 | 380 | 410 |
| Resistance to | Weight average molecular | ×10,000 | 1.78 | 1.79 | 4.53 | 4.64 |
| oxidative degradation | weight (before treatment) | | | | | |
| | Weight average molecular | ×10,000 | 1.74 | 1.83 | 3.62 | 3.85 |
| | weight (after treatment) | | | | | |
| | Weight average molecular | % | 98 | 102 | 80 | 83 |
| | weight retention | | | | | |
| | Peak integral at 5.2 to 6.0 ppm | — | 0.21 | 0.03 | 1.12 | 1.04 |
| | Tensile strength retention | % | 103 | 109 | 83 | 88 |

TABLE 2

| | | | Comparative | Comparative | Comparative | Comparative | Comparative |
|---|---|---|---|---|---|---|---|
| | | | Example 1 | Example 2 | Example 3 | Example 4 | Example 5 |
| Polyester | A-1 | Parts by | 100 | 100 | 100 | 100 | 100 |
| resin (A) | A-2 | weight | — | — | — | — | — |
| | A-3 | | — | — | — | — | — |
| Halide | B-1 | Parts by | — | 0.004 | 1.5 | — | 0.04 |
| compound (B) | B-2 | weight | — | — | — | — | — |
| | B-3 | | — | — | — | — | — |
| | B-4 | | — | — | — | — | — |
| | B-5 | | — | — | — | 0.04 | 0.04 |
| Antioxidant (C) | C-1 | Parts by | — | — | — | — | — |
| | | weight | | | | | |
| Fiber | D-1 | Parts by | — | — | — | — | — |
| inforcement (D) | | weight | | | | | |
| Content of halide compound (B) | | Parts by | — | 0.004 | 1.49 | 0.04 | 0.078 |
| | | weight | | | | | |
| Dispersion diameter | Area-average particle size | nm | — | 11 | 69 | 1900 | 900 |
| Melt retention | Amount of carboxyl | eq/t | 275 | 247 | 239 | 261 | 219 |
| Stability | end groups | | | | | | |
| Mechanical properties | Tensile strength at break | MPa | 54 | 55 | 47 | 47 | 48 |
| | Tensile elongation at break | % | 175 | 175 | 112 | 115 | 124 |
| Resistance to | Weight average molecular | ×10,000 | 1.63 | 1.67 | 1.67 | 1.68 | 1.68 |
| oxidative degradation | weight (before treatment) | | | | | | |
| | Weight average molecular | ×10,000 | 0.62 | 0.90 | 1.07 | 0.69 | 1.06 |
| | weight (after treatment) | | | | | | |
| | Weight average molecular | % | 38 | 54 | 64 | 41 | 63 |
| | weight retention | | | | | | |
| | Peak integral at 5.2 to 6.0 ppm | — | 5.2 | 3.4 | | | |
| | Tensile strength retention | % | 0 | 20 | 28 | 14 | 37 |
| | | | Comparative | Comparative | Comparative | Comparative | Comparative |
| | | | Example 6 | Example 7 | Example 8 | Example 9 | Example 10 |
| Polyester | A-1 | Parts by | 100 | — | — | 70 | 100 |
| resin (A) | A-2 | weight | — | 100 | 100 | — | — |
| | A-3 | | — | — | — | — | — |
| Halide | B-1 | Parts by | — | — | 0.04 | — | — |
| compound (B) | B-2 | weight | — | — | — | — | — |
| | B-3 | | — | — | — | — | — |
| | B-4 | | — | — | — | — | — |
| | B-5 | | — | — | — | — | — |
| Antioxidant (C) | C-1 | Parts by | — | — | — | — | — |
| | | weight | | | | | |
| Fiber | D-1 | Parts by | — | — | — | 30 | — |
| inforcement (D) | | weight | | | | | |
| Content of halide compound (B) | | Parts by | — | — | 0.018 | — | — |
| | | weight | | | | | |
| Dispersion diameter | Area-average particle size | nm | — | — | 12 | — | — |
| Melt retention | Amount of carboxyl | eq/t | 202 | 318 | 216 | 254 | 311 |
| Stability | end groups | | | | | | |
| Mechanical properties | Tensile strength at break | MPa | 55 | 58 | 57 | 131 | 51 |
| | Tensile elongation at break | % | 175 | 175 | 180 | 3.6 | 360 |
| Resistance to | Weight average molecular | ×10,000 | 1.67 | 1.75 | 1.77 | 1.75 | 4.13 |
| oxidative degradation | weight (before treatment) | | | | | | |
| | Weight average molecular | ×10,000 | 1.14 | 1.03 | 1.22 | 1.37 | 1.32 |
| | weight (after treatment) | | | | | | |
| | Weight average molecular | % | 68 | 59 | 69 | 78 | 32 |
| | weight retention | | | | | | |
| | Peak integral at 5.2 to 6.0 ppm | — | | | | | |
| | Tensile strength retention | % | 41 | 27 | 44 | 70 | 0 |

| | | | | Comparative | Comparative | Comparative | Comparative |
|---|---|---|---|---|---|---|---|
| | | | | Example 11 | Example 12 | Example 13 | Example 14 |
| | Polyester | A-1 | Parts by | 100 | — | 100 | 100 |
| | resin (A) | A-2 | weight | — | — | — | — |
| | | A-3 | | — | 100 | — | — |
| | Halide | B-1 | Parts by | 0.1 | 0.1 | 0.1 | 0.6 |
| | compound (B) | B-2 | weight | — | — | — | — |
| | | B-3 | | — | — | — | — |
| | | B-4 | | — | — | — | — |
| | | B-5 | | — | — | — | — |
| | Antioxidant (C) | C-1 | Parts by | — | — | — | — |
| | | | weight | | | | |
| | Fiber | D-1 | Parts by | — | — | — | — |
| | inforcement (D) | | weight | | | | |
| Content of halide compound (B) | | | Parts by | 0.099 | 0.098 | 0.003 | 0.008 |
| | | | weight | | | | |
| | Dispersion diameter | Area-average particle size | nm | 670 | 530 | 580 | 640 |
| | Melt retention | Amount of carboxyl | eq/t | 238 | 252 | 279 | 238 |
| | Stability | end groups | | | | | |
| | Mechanical properties | Tensile strength at break | MPa | 51 | 50 | 54 | 55 |
| | | Tensile elongation at break | % | 150 | 480 | 176 | 178 |
| | Resistance to | Weight average molecular | ×10,000 | 1.65 | 4.52 | 1.67 | 1.68 |
| | oxidative degradation | weight (before treatment) | | | | | |
| | | Weight average molecular | ×10,000 | 0.92 | 2.76 | 0.69 | 0.71 |
| | | weight (after treatment) | | | | | |
| | | Weight average molecular | % | 56 | 61 | 41 | 42 |
| | | weight retention | | | | | |
| | | Peak integral at 5.2 to 6.0 ppm | — | | | | |
| | | Tensile strength retention | % | 24 | 27 | 0 | 0 |

By comparing Examples 1 to 12 to Comparative Examples 1 to 8, Examples 13 and 14 to Comparative Example 9, and Examples 15 and 16 to Comparative Example 10, it can be seen that a material having an excellent balance of melt retention stability, mechanical properties and resistance to oxidative degradation can be obtained by blending the component (A) having a melting point of a specific range with a specific blending amount of the component (B) and allowing a dispersion diameter of the component (B) in the component (A) to be within a specific range. By comparing Examples 1 to 4 to Comparative Examples 1 to 3, it can be seen that a material having an excellent balance of melt retention stability, mechanical properties and resistance to oxidative degradation can be obtained by blending the component (A) with 0.01 to 1 part by weight of the component (B). By comparing Example 11 to Comparative Example 4, and Example 12 to Comparative Example 5, it can be seen that a material having excellent mechanical properties and resistance to oxidative degradation can be obtained by allowing an area average particle size of the component (B) in the thermoplastic polyester resin to be 0.1 to 500 nm.

By comparing Examples 2, 5 and 6 to Examples 7 and 11, it can be seen that a material having an excellent balance of melt retention stability, mechanical properties and resistance to oxidative degradation can be obtained by using an alkali metal iodide as the component (B). By comparing Example 2 to Example 8, it can be seen that the resistance to oxidative degradation is more improved by adding the component (C) in an amount of a specific range. By comparing Example 2 to Examples 9 and 10, it can be seen that a material which has an excellent balance of melt retention stability, mechanical properties and resistance to oxidative degradation can be obtained when a ratio of the total length of kneading discs (lengths of kneading zones) to the full length of a screw of a twin-screw extruder is within a specific range.

By comparing Example 3 to Comparative Examples 11 and Example 15 to Comparative Examples 12, it can be seen that, by using a twin-screw extruder, dispersibility of the component (B) in the component (A) is improved and a material having an excellent balance of melt retention stability, mechanical properties and resistance to oxidative degradation can be obtained. By comparing Example 3 to Comparative Examples 13 and Example 4 to Comparative Examples 14, it can be seen that, by melt-blending the component (A) and the component (B) using a twin-screw extruder, dispersibility of the component (B) in the resin composition is improved more than when the component (B) is added during a polymerization of the component (A) and furthermore the content of the component (B) can be increased and therefore a material having a more excellent balance of melt retention stability, mechanical properties and resistance to oxidative degradation can be obtained.

By comparing Examples 3 and 4 to Examples 15 and 16, it can be seen that, by allowing a molecular weight of the component (A) to be in a specific range, the oxidative degradation by shear heating during a melt process can be prevented and therefore the consumption of the component (B) during a melt process is decreased and the content of the component (B) in the resin composition can be increased and consequently consumption of the component (B) during a melt process is decreased and a material having a more excellent balance of melt retention stability, mechanical properties and resistance to oxidative degradation can be obtained.

1-12. (canceled)

13. A thermoplastic polyester resin composition comprising 100 parts by weight of a thermoplastic polyester resin (A) having a melting point of 180 to 250° C. and 0.01 to 0.6 parts by weight of a metal halide (B), wherein an area average particle size of the metal halide (B) in the thermoplastic polyester resin composition is 0.1 to 500 nm.

14. The thermoplastic polyester resin composition according to claim 13, wherein the metal halide (B) is an alkali metal halide.

15. The thermoplastic polyester resin composition according to claim 13, wherein a weight average molecular weight retention of the thermoplastic polyester resin (A) is 80% or more after the thermoplastic polyester resin composition is heat-treated at 180° C. for 250 hours under an atmospheric pressure.

16. The thermoplastic polyester resin composition according to claim 13, wherein the thermoplastic polyester resin (A) is a polybutylene terephthalate resin.

17. The thermoplastic polyester resin composition according to claim 13, further comprising an antioxidant (C) in an amount of 0.01 to 1 part by weight with respect to 100 parts by weight of the thermoplastic polyester resin (A).

18. The thermoplastic polyester resin composition according to claim 17, wherein the antioxidant (C) includes a thioether compound.

19. The thermoplastic polyester resin composition according to claim 13, further comprising a reinforcing fiber (D) in an amount of 1 to 100 parts by weight with respect to 100 parts by weight of the thermoplastic polyester resin (A).

20. The thermoplastic polyester resin composition according to claim 13, further comprising a flame retardant (E) in an amount of 1 to 100 parts by weight with respect to 100 parts by weight of the thermoplastic polyester resin (A).

21. The thermoplastic polyester resin composition according to claim 13, wherein the tensile strength retention of the molded article is 80% or more after the molded article comprising the thermoplastic polyester resin composition is heat-treated at 180° C. for 250 hours under an atmospheric pressure.

22. The thermoplastic polyester resin composition according to claim 13, wherein when a ¹H-NMR spectrum of the thermoplastic polyester resin (A) is measured after heat-treatment at 180 ° C. for 250 hours under an atmospheric pressure, a peak integral 5.2 to 6.0 ppm is 0 to 2 if a peak integral 3.6 to 4.0 ppm is defined as 100.

23. A molded article comprising the thermoplastic polyester resin composition according to claim 13.

24. A method of producing the thermoplastic polyester resin composition according to claim 13, comprising melt-blending the thermoplastic polyester resin (A) having a melting point of 180 to 250° C. and the metal halide (B) with a twin-screw extruder, wherein a proportion of a total length of kneading discs to a full length of a screw of the twin-screw extruder is 5 to 50%.
